(19) United States
(12) Patent Application Publication
(10) Pub. No.: US 2009/0084480 A1
(43) Pub. Date: Apr. 2, 2009

(54) Mesa Mount Patch for Mounting A Rigid Structure in a Tire

(75) Inventors: John David Adamson, Simpsonville, SC (US); Jay Clifford Sinnett, Greenville, SC (US)

Correspondence Address: DORITY & MANNING, PA & MICHELIN NORTH AMERICA, INC, P O BOX 1449, GREENVILLE, SC, 29602-1449, US

(73) Assignee: MICHELIN RECHERCHE ET TECHNIQUE S.A., Granges-Paccot (CH)

(21) Appl. No.: 11/664,479

(22) PCT Filed: Nov. 12, 2004
(86) PCT No.: PCT/US2004/038396

§ 371 Date: Nov. 19, 2008

(51) Int. Cl. B29C 73/10

(52) U.S. Cl. 152/367

(57) ABSTRACT

A new and useful patch (305) that may be used to mount a relatively rigid structure (300) onto the surface of a tire (315) is provided. Such rigid structure (300) may be, by way of example only, an electronics device, printed circuit board, piezoelectric component, or other devices that are relatively more rigid than the material from which the patch (305) or tire (315) is constructed. The present invention helps reduce and control stress concentrations that occur proximate to such structures as the tire experiences repeated deformation during its use.

### FIELD OF THE INVENTION

The present invention relates to a new and useful patch that may be used to mount a relatively rigid structure onto the surface of a tire. Such rigid structure may be, by way of example only, an electronics device, printed circuit board, piezoelectric component, or other devices that are relatively more rigid than the material from which the patch or tire is constructed. The present invention helps reduce and control stress concentrations that occur proximate to such structures as the tire experiences repeated deformation during its use.

### BACKGROUND OF THE INVENTION

The attachment of a structure or device to the surface of tire has numerous useful and desirable applications. By way of example, U.S. Pat. No. 6,734,791, owned by applicants' assignee, describes an electronics component assembly that is located within and connected to an inner portion of a tire. The electronics component may be used to provide various information about the tire condition such as temperature and pressure. Techniques for attaching various structures, including electronic devices, to a tire's surface have been described. For example, U.S. Pat. No. 6,782,741, owned by applicants' assignee, describes a patch constructed from a rubber mix that may be used for fastening an electronic module onto a tire. U.S. Pat. Nos. 6,782,741 and 6,734,791 are incorporated herein by reference.

Stress concentrations may occur, however, when a structure that is relatively more rigid that the elastomeric materials typically used in tire construction is attached to the surface of a tire. For example, when a relatively rigid structure is attached directly to a patch, over time and with the repeated flexing that occurs during tire use, the edge of the electronic device may contact the underlying rubber. By way of example, FIG. 1 illustrates a cross-section of a device 100 attached to a patch 105 that is in turn adhered to the surface 110 of a tire 115. Device 100 is relatively rigid as compared to the materials, typically elastomeric, using in the construction of tire 115. As tire 115 experiences a stretching deformation, indicated by arrows A and B, device 100 will resist any stretching deformation or strain, which in turn causes stress concentrations proximate to points C and D. Because the bond between patch 105 and tire 115 is strong, stress may occur at or near the vicinity of points C and D. FIG. 1 is provided by way of example only. Similar effects can occur even when device 100 is partially or completely embedded within patch 10.

Accordingly, a patch that reduces or controls such stress concentrations desirable. This and other features and advantages of the invention will be set forth in part in the following description, or may be apparent from the description.

### SUMMARY OF THE INVENTION

The present invention provides a patch that may be used to mount a relatively rigid structure onto the surface of a tire. The present invention helps reduce and control the stress concentrations that will generally occur within the patch at locations adjacent to the edges of an attached or embedded structure. The present invention may be used with a variety of different structures including electronics, piezoelectrics, printed circuit boards, and numerous other possibilities. In the case of piezoelectrics, the present invention can be fashioned so as to help control, rather than just only minimize or eliminate, the amount of stress experienced by the piezoelectric assembly. Various exemplary embodiments of the present invention will now be summarized

In one exemplary embodiment, the present invention provides a device for fastening to a tire. The device includes a patch constructed from an elastomeric material and configured for attaching to the surface of the tire. The patch has a first peripheral edge and a peripheral surface extending around the patch. A relatively rigid insert is carried by the patch. The insert can be electronics, a printed circuit board, or a variety of other components. The insert has a second peripheral edge that extends around the insert. The insert is in contact with the first peripheral edge of the patch. The second peripheral edge of the insert is positioned past the first peripheral edge of the patch along at least a portion of the second peripheral edge so as to form an overhang of the insert relative to the patch. Although not required, it is preferable that the overhang be present around the entire second peripheral edge of the insert.

Various additional features may be provided to this exemplary embodiment of the present invention to further enhance the ability of the device to control and minimize stress concentrations. For example, the peripheral surface may be configured such that it is concave in shape. Alternatively, the peripheral surface of the patch may be configured to be substantially normal to the receiving surface of the tire at locations proximate to the tire. Similarly, the peripheral surface of the patch can be configured to be substantially normal to the attachment surface of the insert at locations proximate to the insert. As another alternative, the peripheral surface of the patch can be configured to be substantially arcuate to the receiving surface of the tire at locations proximate to the tire. Likewise, the peripheral surface of the patch can be configured to be substantially arcuate to the attachment surface of the insert at locations proximate to the insert. Additionally, the thickness of the patch may also be varied to reduce stress concentrations occurring in the patch proximate to the overhang as the tire experiences deformations. The effect is generally achieved by increasing the thickness of the patch.

In another exemplary embodiment, a device for fastening to a tire is provided that includes a patch constructed from a rubber mix. The patch defines a first length and a peripheral surface. An insert is carried by the patch, wherein the insert defines a second length. The patch is configured for fastening to the tire in a manner so that the length of the insert exceeds the length of the patch. As such, the insert extends past the patch so as to form an overhang of the patch relative to the insert. Variations to the thickness and shape of the peripheral surface may be used as described with the previous exemplary embodiments.

In still another exemplary embodiment of the present invention, a device for fastening to a tire is provided that includes a patch constructed from an elastomeric material. The patch defines a first peripheral surface extending around the patch. A relatively rigid insert is carried by the patch. The insert defines a second peripheral surface extending around the insert. The patch is configured for attaching to the surface of the tire. The first and second peripheral surfaces are substantially coplanar.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 illustrates a cross-sectional view of an exemplary tire patch bearing a relatively rigid device and attached to a tire surface. Stress concentrations and other effects associated with this construction are discussed above.

FIG. 2 illustrates a cross-sectional view of an exemplary embodiment of the present invention.

FIG. 3 illustrates a cross-sectional view of another exemplary embodiment of the present invention.

FIGS. 4A, 4B, and 4C illustrate cross-sectional views of additional exemplary embodiments of the present invention.

FIG. 5 illustrates a cross-sectional view of another exemplary embodiment of the present invention.

Repeat use of reference characters throughout the present specification and appended drawings is intended to represent same or analogous features or elements of the invention.

### DETAILED DESCRIPTION OF THE PREFERRED EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

An exemplary embodiment of a tire patch according to the present invention is illustrated in FIG. 2. A device 200 is adhered to a receiving surface 210 of tire 215 using mesa patch 205. Device 200 generically represents a variety of structures, relatively more rigid than the materials used to construct tire 215, that may be placed onto surface 210. By way of example only, device 200 may be various electronics, piezoelectrics, or printed circuit boards. Furthermore, non-electronic components are also envisioned.

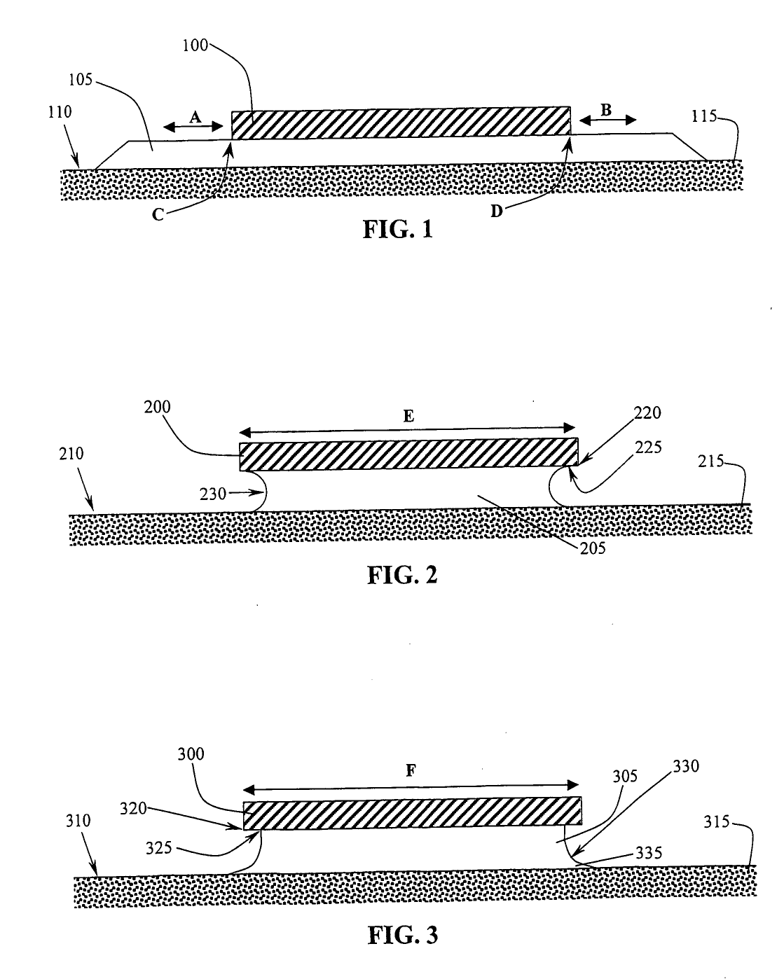

Unlike the patch in FIG. 1, patch 205 includes certain features that reduce stress concentrations. Notably, the length E of device 200 is greater than the length of patch 205 such that peripheral edge 220 of device 200 extends slightly past peripheral edge 225 of patch 205. Accordingly, as 215 experiences deformations during operation, the stress concentrations at the interface of edge 220 are eliminated because edge 220 is no longer in contact with patch 205. Furthermore, stress concentrations occurring at the interface of patch 205 and edge 220 are also reduced because patch 205 is elevated from the receiving surface 210 of tire 215. Finally, peripheral surface 230 is created with a radius to provide a concave shape as illustrated in FIG. 2. Such shape further acts to reduce stress concentrations in patch 205.

FIG. 3 provides another exemplary embodiment of the present invention using an elevated patch 305. Device 300 is adhered to tire 315 using of patch 305. As with the previous embodiment, the length F of device 300 exceeds the length of patch 305 such that peripheral edge 320 of device 300 extends past peripheral edge 325 of patch 305. Peripheral surface 330 is also provided with a slight taper 335 at locations adjacent to where patch 305 contacts tire 315 so as to create an arcuate shape when viewed in cross section as shown in FIG. 3. Again, these features operate to reduce and control the stress concentrations experienced by patch 305 as tire 315 experiences various deformations during operation.

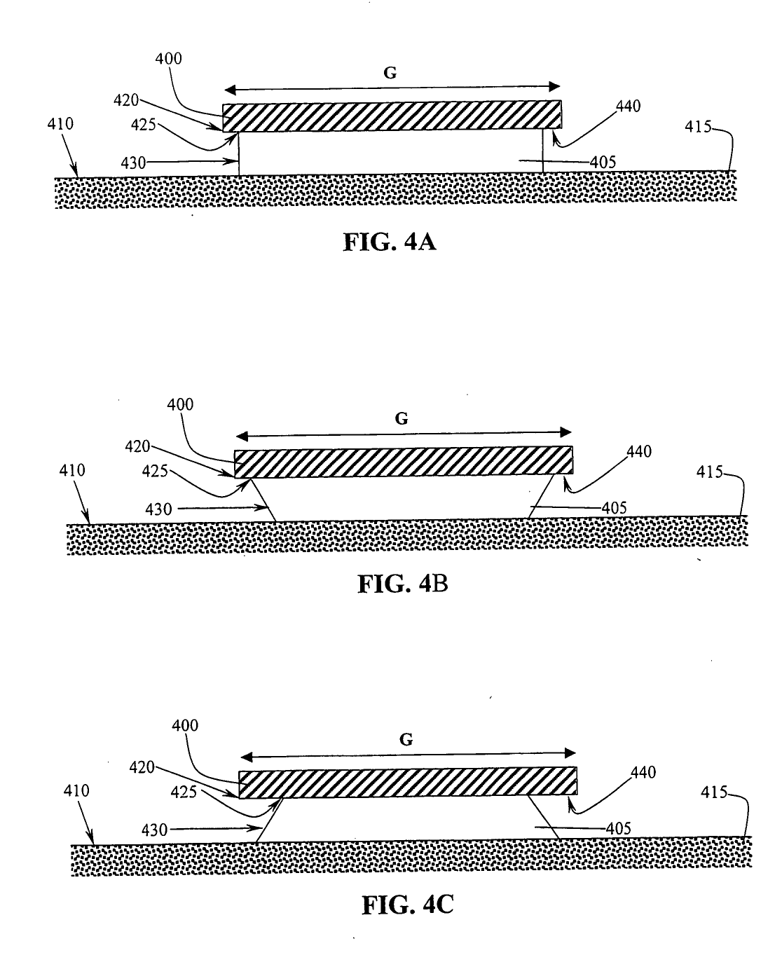

Another exemplary embodiment of the present invention is illustrated in FIG. 4A. In a fashion consistent with the previously described exemplary embodiments, device 400 has a length G that is greater than the length of patch 405 used to adhere device 400 to tire 415. As a result, peripheral edge 420 of device 400 extends past peripheral edge 425 of patch 405. Unlike the previous embodiments, no taper or radius is used for peripheral surface 430. Instead, peripheral surface 430 is substantially normal to receiving surface 410 of tire 415 and attachment surface 440 of device 400. The reduction in stress concentration is achieved by the overhang of patch 405 and the elevation of device 400 above surface 410. As shown in comparing the embodiments of FIGS. 4A, 4B, and 4C, the angle of peripheral surface 430 relative to receiving surface 410 can be varied. It should be understood that the shape of surface 430 may also be varied within the scope of the present invention.

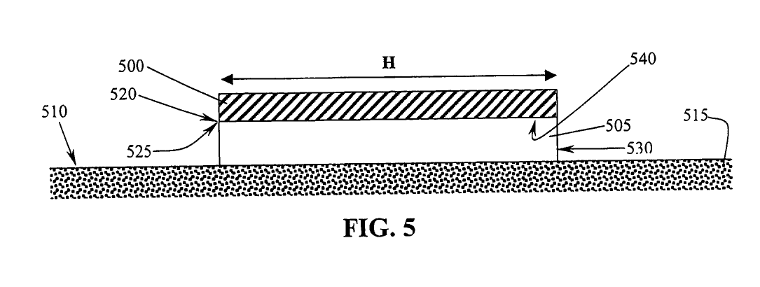

Finally, FIG. 5 also represents another exemplary embodiment of the present invention in which the length H of device 500 is identical to the length of patch 505. More specifically, there is no overhang of device 500 in that edges 520 and 525 are flush with one another. Peripheral surface 530 is also substantially normal to receiving surface 510 and the attachment surface 540 of patch 505. Accordingly, for this embodiment of the present invention, the reduction in stress concentrations is realized by the elevation of device 500 above surface 510 and the absence of any portion of patch 505 extending past the edge 520 of device 500.

The present invention is not limited to the relative sizes and proportions illustrated in the figures associated with the exemplary embodiments described above. Various other configurations and proportions may be used. In addition, features described with regard to one embodiment may be combined with features of other exemplary embodiments to yield additional embodiments of the present invention. It should be understood that the present invention includes these and other various modifications that can be made to the exemplary embodiments of the tire patch as described herein that come within the scope of the appended claims and their equivalents.

What is claimed is:

1. A device for fastening to a tire, said device comprising:
a patch constructed from an elastomeric material, said patch having a first peripheral edge extending around said patch, said patch defining a peripheral surface extending around said patch; and
a relatively rigid insert carried by the patch, said insert having a second peripheral edge extending around said insert, said insert being in contact with said first peripheral edge of said patch;
wherein said patch is configured for attaching to the surface of the tire, and wherein said second peripheral edge of said insert is positioned past said first peripheral edge along at least a portion of said second peripheral edge so as to form an overhang of said insert relative to said patch.

2. A device for fastening to a tire as in claim 1, wherein said peripheral surface is positioned between said insert and the tire and is concave in shape.

3. A device for fastening to a tire as in claim 1, wherein the tire defines a receiving surface for said patch, and wherein said peripheral surface of said patch is configured to be substantially normal to the receiving surface of the tire at locations proximate to the tire.

4. A device for fastening to a tire as in claim 1, wherein said insert defines an attachment surface for contact with said patch, and wherein said peripheral surface of said patch is substantially normal to said attachment surface of said insert at locations proximate to said insert.

5. A device for fastening to a tire as in claim 1, wherein the tire defines a receiving surface for said patch, and wherein said peripheral surface of said patch is configured to be substantially arcuate to said receiving surface of the tire at locations proximate to the tire.

6. A device for fastening to a tire as in claim 5, wherein said insert defines an attachment surface for contact with said patch, and wherein said peripheral surface of said patch is substantially arcuate to said attachment surface of said insert at locations proximate to said insert.

7. A device for fastening to a tire as in claim 1, wherein said insert defines an attachment surface for contact with said patch, and wherein said peripheral surface of said patch is substantially arcuate to said attachment surface of said insert at locations proximate to said insert.

8. A device for fastening to a tire as in claim 1, wherein said overhang is present around the entire said second peripheral edge of said insert.

9. A device for fastening to a tire as in claim 1, where said patch has a thickness that is configured to reduce stress concentrations occurring in said patch proximate to said overhang as the tire experiences deformations.

10. A device for fastening to a tire as in claim 9, wherein said peripheral surface is arcuate in shape at portions proximate to said overhang.

11. A device for fastening to a tire, said device comprising:
a patch constructed from a rubber mix, said patch defining a first length and a peripheral surface; and
an insert carried by said patch, wherein said insert defines a second length;
wherein said patch is configured for fastening to the tire, and wherein said second length exceeds said first length such that said insert extends past said patch so as to form an overhang of said patch relative to said insert.

12. A device for fastening to a tire as in claim 11, wherein said peripheral surface is concave in shape.

13. A device for fastening to a tire as in claim 11, wherein the tire defines a receiving surface for said patch, said wherein said peripheral surface of said patch is configured to be substantially normal to the receiving surface of the tire at locations proximate to the tire.

14. A device for fastening to a tire as in claim 11, wherein said insert defines an attachment surface for contact with said patch, and wherein said peripheral surface of said patch is substantially normal to said attachment surface of said insert at locations proximate to said insert.

15. A device for fastening to a tire as in claim 11, wherein the tire defines a receiving surface for said patch, and wherein said peripheral surface of said patch is configured to be substantially arcuate to said receiving surface of the tire at locations proximate to the tire.

16. A device for fastening to a tire as in claim 15, wherein said insert defines an attachment surface for contact with said patch, and wherein said peripheral surface of said patch is substantially arcuate to said attachment surface of said insert at locations proximate to said insert.

17. A device for fastening to a tire as in claim 11, wherein said insert defines an attachment surface for contact with said patch, and wherein said peripheral surface of said patch is substantially arcuate to said attachment surface of said insert at locations proximate to said insert.

18. A device for fastening to a tire as in claim 11, wherein said overhang is present around the entirety of said peripheral surface.

19. A device for fastening to a tire as in claim 11, where said patch has a thickness that is configured to reduce stress concentrations occurring in said patch proximate to said overhang as the tire experiences deformations.

20. A device for fastening to a tire as in claim 19, wherein said peripheral surface is concave in shape.

21. A device for fastening to a tire, the tire having a surface, said device comprising:
a patch constructed from an elastomeric material, said patch defining a first peripheral surface extending around said patch;
a relatively rigid insert carried by the patch, said insert defining having a second peripheral surface extending around said insert;
wherein said patch is configured for attaching to the surface of the tire, and wherein said first and second peripheral surfaces lines are substantially coplanar.

22. A device for fastening to a tire, the tire having a surface, said device comprising:
a patch constructed from an elastomeric material, said patch defining a first peripheral surface extending at least partially around said patch, said patch having a thickness;
a relatively rigid insert carried by the patch, said insert defining having a second peripheral surface extending at least partially around said insert;
wherein said patch is configured for attaching to the surface of the tire, and wherein said second peripheral extends past at least a portion of said first peripheral surface so as to create an overhang, and wherein said first peripheral surface and said thickness of said patch are configured so as control stress concentrations occurring in said patch during operation of the tire.
